(19) United States
(12) Patent Application Publication
(10) Pub. No.: US 2018/0017236 A1
(43) Pub. Date: Jan. 18, 2018

(54) LOW VOLUME MODULAR LIGHT ASSEMBLIES

(71) Applicant: 3form, LLC, Salt Lake City, UT (US)

(72) Inventors: Bruce Clark, Redmond, WA (US); Kyle Burt, Salt Lake City, UT (US)

(21) Appl. No.: 15/719,070

(22) Filed: Sep. 28, 2017

Related U.S. Application Data
(63) Continuation of application No. 29/560,673, filed on Apr. 8, 2016.
(60) Provisional application No. 62/402,501, filed on Sep. 30, 2016.

(51) Int. Cl. F21V 19/00; F21V 21/005; F21S 2/00; F21V 23/06; F21V 21/04

(52) U.S. Cl. CPC F21V 19/0005; F21V 23/06; F21V 21/04; F21S 2/005; F21V 19/003; F21V 21/005

(57) ABSTRACT

Embodiments are directed to a linear baffle light that includes the following: a substructure that forms an enclosure for one or more lights, a customizable wrap that surrounds various surfaces of the substructure, one or more grommets embedded in the customizable wrap configured to connect the linear baffle light to other linear baffle lights, and an electrical connector comprising contact pins that are embedded in the customizable wrap. In some cases, the customizable wrap is a film lamination wrap that is 1/32″ thick, and allows users to cut the wrap into different sizes and shapes.

### CROSS-REFERENCE TO RELATED APPLICATIONS

This application claims priority to and the benefit of U.S. Provisional Patent Application No. 62/402,501, entitled “Low Volume Modular Light Assemblies,” filed on Sep. 30, 2016, which application is incorporated by reference herein in its entirety. This application also claims priority to and the benefit of U.S. Design application Ser. No. 29/560,673, entitled “Light Fixture,” filed on Apr. 8, 2016, which application is also incorporated by reference herein in its entirety.

### BACKGROUND

Certain trends in lighting applications involve the coupling of multiple smaller lighting fixtures or modules to form a larger modular assembly. Limitations to such modular lighting systems include the formation of unsightly gaps or seams between two adjacent modules at the site of coupling, which may detract from the aesthetic appeal or the functionality of such lighting assemblies. Moreover, a typical lighting module requires the use of several pieces of connective and/or mounting hardware in order to properly couple modules together and to mount the completed assembly. Such connective and/or mounting hardware is also typically bulky and includes numerous pieces, which further detract from the look and operability of such lighting assemblies.

In addition, ease of assembly is hampered by the often complicated coupling and/or mounting requirements, which can make it difficult to quickly arrange lighting modules into a desired assembly. Also, in many cases, the resulting assembly is too bulky and large, taking up more valuable space than is desired. Accordingly, there are a number of disadvantages in the present field of modular lighting.

### BRIEF SUMMARY

Embodiments described herein are directed to lighting assemblies and to linear baffle lights. In one embodiment, a lighting assembly is provided which includes a lighting module. The lighting module includes the following: lighting components, a bottom element that transmits light emitted from the lighting components when the lighting components are illuminated, and an end member coupled to the bottom element. The end member has an interior recess that receives a connecting bracket. The connecting bracket enables coupling of the end member of the lighting fixture to another end element of another lighting fixture. Optionally, a second lighting module is provided in the lighting assembly. The second lighting module includes an end member joined to the end member of the lighting module via the connecting bracket.

In another embodiment, a linear baffle light is provided. The linear baffle light includes a substructure that forms an enclosure for one or more lights, a customizable wrap that surrounds various surfaces of the substructure, fasteners embedded in the customizable wrap that connect the linear baffle light to other linear baffle lights, and an electrical connector which includes contact pins that are embedded in the customizable wrap. In some cases, the customizable wrap is a film lamination wrap that has a thickness in the range of 1/16 to 1/32 inches.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be apparent to one of ordinary skill in the art from the description, or may be learned by the practice of the teachings herein. Features and advantages of embodiments described herein may be realized and obtained by means of the instruments and combinations particularly pointed out in the appended claims. Features of the embodiments described herein will become more fully apparent from the following description and appended claims.

### BRIEF DESCRIPTION OF THE DRAWINGS

To further clarify the above and other features of the embodiments described herein, a more particular description will be rendered by reference to the appended drawings. It is appreciated that these drawings depict only examples of the embodiments described herein and are therefore not to be considered limiting of its scope. The embodiments will be described and explained with additional specificity and detail through the use of the accompanying drawings in which:

FIG. 1 illustrates a bottom perspective view of a lighting assembly.

FIG. 2 illustrates a top perspective view of a lighting assembly.

FIG. 3 illustrates a front perspective view of a lighting assembly with a top cover piece removed.

FIG. 4 illustrates a front perspective view of a lighting assembly that includes a connector in a first position.

FIG. 5 illustrates a front perspective view of a lighting assembly that includes a connector in a second position.

FIG. 6 illustrates a top perspective view of a lighting assembly with two portions adjoined via a connector.

FIG. 7 illustrates a top perspective view of a lighting assembly with two portions adjoined via a connector and the cover removed.

FIG. 8 illustrates an exploded perspective view of a lighting assembly a connector.

FIG. 9 illustrates a top perspective view of a lighting assembly having an LED light strip.

FIG. 10 illustrates a front perspective view of a connecting bracket used in conjunction with a lighting assembly.

FIG. 11 illustrates a top element of a lighting assembly.

FIG. 12 illustrates a rotated top perspective view of a lighting assembly.

FIG. 13 illustrates a front facing view of an embodiment of a linear baffle light.

FIGS. 14A and 14B illustrate top views of an embodiment of a linear baffle light.

FIG. 15 illustrates a front perspective view of an L-shaped lighting assembly.

FIG. 16 illustrates an alternate front perspective view of an L-shaped lighting assembly.

FIG. 17 illustrates a bottom perspective view of an L-shaped lighting assembly.

FIG. 18 illustrates a top perspective view of a wrap for a linear baffle light.

FIG. 19 illustrates a front facing view of a wrap for a linear baffle light.

FIG. 20 illustrates a side facing view of a wrap for a linear baffle light.

FIG. 21 illustrates an alternate top facing view of a wrap for a linear baffle light.

FIG. 22 illustrates a grid of LED lighting strips for arranging in linear baffle lights.

### DETAILED DESCRIPTION

Certain embodiments described herein may be utilized to address one or more of the foregoing disadvantages (and/or other disadvantages) in the art. Certain embodiments described herein are directed to systems, methods, and devices for improving the modularity and/or connectivity of lighting modules, so as to enable the formation and utilization of beneficial modular light assemblies.

Before describing the present disclosure in detail, it is to be understood that this disclosure is not limited to the specific parameters of the particularly exemplified systems, apparatus, assemblies, products, devices, kits, methods, and/or processes, which may, of course, vary. It is also to be understood that much, if not all of the terminology used herein is only for the purpose of describing particular embodiments of the present disclosure, and is not necessarily intended to limit the scope of the disclosure in any particular manner. Thus, while the present disclosure will be described in detail with reference to specific configurations, embodiments, and/or implementations thereof, the descriptions are illustrative only and are not to be construed as limiting the scope of the claimed invention.

Various aspects of the present disclosure, including devices, systems, methods, etc., may be illustrated with reference to one or more exemplary embodiments or implementations. As used herein, the terms “exemplary embodiment” and/or “exemplary implementation” means “serving as an example, instance, or illustration,” and should not necessarily be construed as preferred or advantageous over other embodiments or implementations disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

Furthermore, unless defined otherwise, all technical and scientific terms used herein have the same meaning as commonly understood by one of ordinary skill in the art to which the present disclosure pertains. While a number of methods, materials, components, etc. similar or equivalent to those described herein can be used in the practice of the present disclosure, only certain exemplary methods, materials, components, etc. are described herein.

It will be noted that, as used in this specification and the appended claims, the singular forms “a,” “an” and “the” include plural referents unless the content clearly dictates otherwise. Thus, for example, reference to a “column” includes one, two, or more columns. Similarly, reference to a plurality of referents should be interpreted as comprising a single referent and/or a plurality of referents unless the content and/or context clearly dictate otherwise. Thus, reference to “columns” does not necessarily require a plurality of such columns. Instead, it will be appreciated that independent of conjugation; one or more columns are contemplated herein.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” and “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

Various aspects of the present disclosure can be illustrated by describing components that are coupled, attached, connected, and/or joined together. As used herein, the terms “coupled,” “attached,” “connected,” and/or “joined” are used to indicate either a direct association between two components or, where appropriate, an indirect association with one another through intervening or intermediate components. In contrast, when a component is referred to as being “directly coupled,” “directly attached,” “directly connected,” and/or “directly joined” to another component, no intervening elements are present or contemplated.

Thus, as used herein, the terms “connection,” “connected,” and the like do not necessarily imply direct contact between the two or more elements. In addition, components that are coupled, attached, connected, and/or joined together are not necessarily (reversibly or permanently) secured to one another. For instance, coupling, attaching, connecting, and/or joining can comprise placing, positioning, and/or disposing the components together or otherwise adjacent in some implementations.

As used herein, directional and/or arbitrary terms, such as “top,” “bottom,” “front,” “back,” “forward,” “rear,” “left,” “right,” “up,” “down,” “upper,” “lower,” “inner,” “outer,” “internal,” “external,” “interior,” “exterior,” “anterior,” “posterior,” “proximal,” “distal,” and the like can be used only for convenience and/or solely to indicate relative directions and/or orientations and may not otherwise be intended to limit the scope of the disclosure, including the specification, invention, and/or claims. According, such directional and/or arbitrary terms are not to be construed as necessarily requiring a specific order or position.

To facilitate understanding, like reference numerals have been used, where possible, to designate like elements common to the figures. Furthermore, alternative configurations of a particular element may each include separate letters appended to the element number. Accordingly, an appended letter can be used to designate an alternative design, structure, function, implementation, and/or embodiment of an element or feature without an appended letter. Similarly, multiple instances of an element and or sub-elements of a parent element may each include separate letters appended to the element number.

In each case, the element label may be used without an appended letter to generally refer to instances of the element or any one of the alternative elements. Element labels including an appended letter can be used to refer to a specific instance of the element or to distinguish or draw attention to multiple uses of the element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where two or more values, or a range of values (e.g., less than, greater than, at least, and/or up to a certain value, and/or between two recited values) is disclosed or recited, any specific value or range of values falling within the disclosed values or range of values is likewise disclosed and contemplated herein. Thus, disclosure of an illustrative measurement or distance less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

The terms “approximately,” “about,” and “substantially” as used herein represent an amount or condition close to the stated amount or condition that still performs a desired function or achieves a desired result. For example, the terms “approximately,” “about,” and “substantially” may refer to an amount or condition that deviates by less than 10%, or by less than 5%, or by less than 1%, or by less than 0.1%, or by less than 0.01% from a stated amount or condition.

Various modifications can be made to the illustrated embodiments without departing from the spirit and scope of the invention as defined by the claims. Thus, while various aspects and embodiments have been disclosed herein, other aspects and embodiments are contemplated. It is also noted that systems, apparatus, assemblies, products, devices, kits, methods, and/or processes, according to certain embodiments of the present disclosure may include, incorporate, or otherwise comprise properties, features, components, members, and/or elements described in other embodiments disclosed and/or described herein. Thus, reference to a specific feature in relation to one embodiment should not be construed as being limited to applications only within said embodiment. The headings used herein are for organizational purposes only and are not meant to be used to limit the scope of the description or the claims.

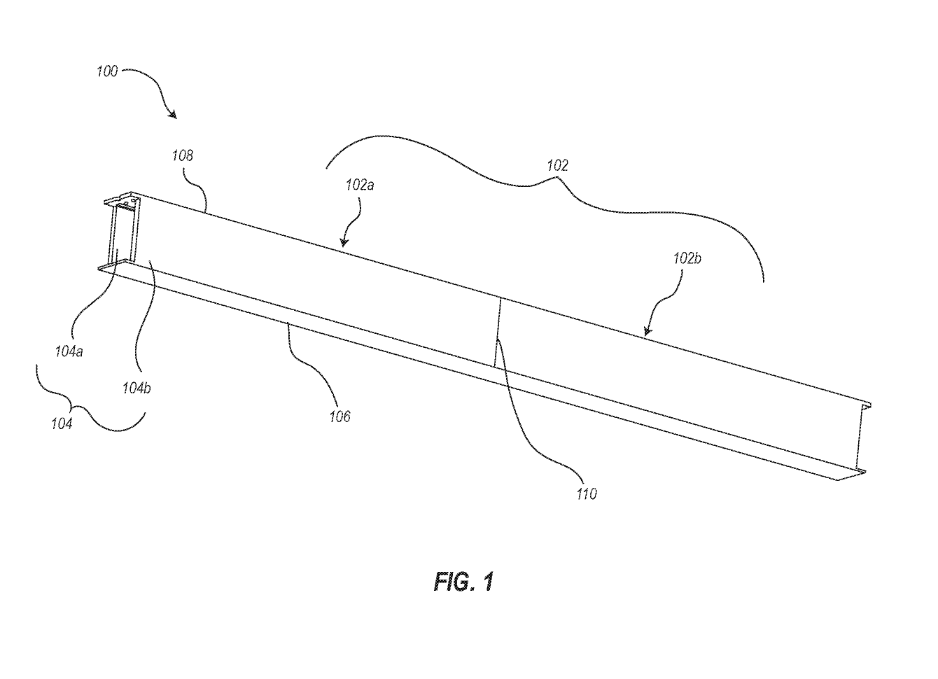

FIG. 1 illustrates a bottom perspective view of a lighting assembly 100 formed from a pair of coupled lighting modules 102a and 102b (referred to generically as lighting modules 102). The illustrated embodiment of FIG. 1 is formed as a linear-shaped lighting assembly that has two lighting modules (102a and 102b), although other lighting assemblies may include substantially any number of lighting modules 102. These lighting modules may have a variety of different shapes, lengths, curvatures, etc. The lighting modules meet at an interface 110, where they are attached together to form a single lighting assembly.

Multiple different lighting modules may be combined to form a desired lighting assembly arrangement. This lighting assembly may be a linear assembly (as shown in FIG. 1), a cylindrical- or ring-shaped assembly, a curved assembly, an ovoid assembly, an L-shaped assembly, or other assembly shape. It will be understood that modular assemblies of various shapes and forms, for use in different applications and/or spaces, can be formed by combining and arranging a number of lighting modules having shapes that are linear, curved, angled, and/or otherwise formed. In any given lighting fixture, each lighting module may have a different size or shape. Or, alternatively, each lighting module may have substantially the same shape and size.

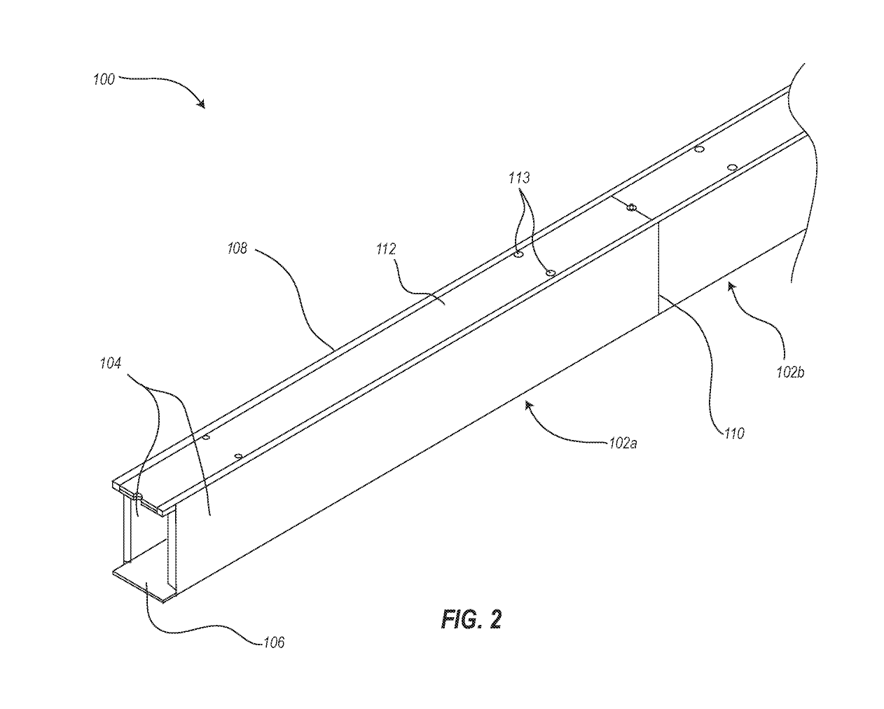

As shown in FIG. 1, each module in the lighting assembly 100 includes two side elements 104a and 104b (collectively referred to as side elements 104), a bottom element 106, and a top element 108 (shown more prominently in FIG. 2). Indeed, in FIG. 2, a removable cover 112 is separably coupled to the top element 108. The removable cover 112 may be attached to the top element 108 using nails, screws, clasps or other attachment means. In some cases, where screws or nails are used, the screws or nails may be inserted through the removable cover 112 at apertures 113. As explained in more detail below, the removable cover 112 provides access to the interior of the corresponding module 102, which enables assembly of different modules 102 into a full assembly, and also enables easier installation of an assembly at a desired location.

In some embodiments, one or more of the side elements 104 are configured as a shade to block, reduce, soften, and/or disperse the passage of light through the side elements 104. In other embodiments, one or more of the side elements 104 are translucent so as to at least partially allow the passage of light therethrough. In some embodiments, one or more of the side elements 104 include an aesthetic covering or display. Additionally, or alternatively, the side elements 104 may be colored, shaded, textured, and/or otherwise modified for desired aesthetic or functional purposes.

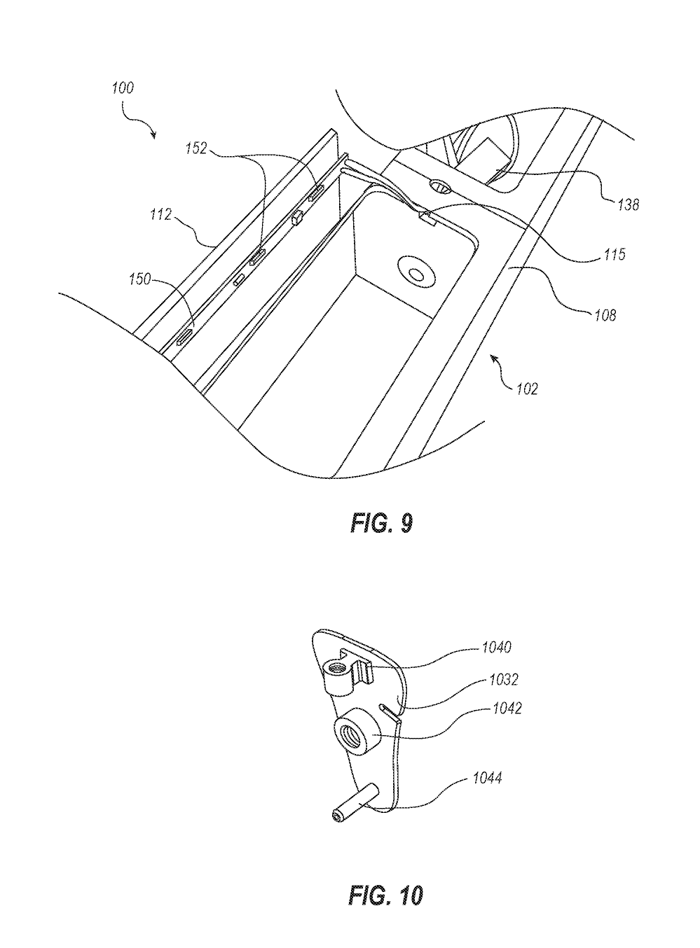

In one implementation, the lighting assembly 100 is positioned so that an arrangement of lighting components (e.g., light emitting diodes (LEDs)) is coupled to or positioned against the top element 108 (this is shown in greater detail in FIG. 9). When in operation, lighting components direct light towards and at least partially through the bottom element 106 to provide illumination to the vicinity of the lighting assembly 100. In some embodiments, the bottom element 106 is configured to diffuse, disperse, or soften the passing light.

In some embodiments, the bottom element 106 is formed from or includes one or more glass or thermoplastic sheets or panels. These sheets or panels may be made from acrylic (e.g., polymethyl methacrylate (PMMA)), polyethylene terephthalate with glycol modification (PETG), and/or polycarbonate (PC). In some embodiments, the bottom element 106 includes a film, paint, or other coating applied to its inner and/or outer surfaces. Additionally, or alternatively, the bottom element 106 may include surface textures (e.g. such as rough or smooth textures) or patterns that are designed to deflect or diffuse light in a specified manner. The bottom elements may be interchangeable, thereby allowing users to apply customized light deflection or light diffusing characteristics in each lighting assembly.

In some module embodiments, the bottom element 106, the side elements 104, and/or the top element 108 include a resin or other thermoplastic material capable of being formed into a panel configuration for use in the lighting assembly 100. Non-limiting examples of suitable thermoplastic materials include polyethylene terephthalate (PET), polyethylene terephthalate with glycol modification (PETG), acrylonitrile butadiene-styrene (ABS), polyvinyl chloride (PVC), polyvinyl butyral (PVB), ethylene vinyl acetate (EVA), polycarbonate (PC), styrene, polymethyl methacrylate (PMMA), polyolefins (low and high density polyethylene, polypropylene), thermoplastic polyurethane (TPU), and cellulose-based polymers (cellulose acetate, cellulose butyrate or cellulose propionate). Other embodiments, may utilize one or more elements formed from or including fabric, paper, recycled or post-consumer products, and combinations thereof, for example.

As mentioned above, the lighting assembly 100 has a modular configuration and is arranged from a plurality of individual lighting modules 102. Such a modular configuration enables the formation of larger lighting assemblies than could otherwise be provided by single unit devices in a cost effective manner. For example, in contrast to the storage, transport, and installation issues related to bulky, large devices not equipped with modular functionality, at least some of the modular devices described herein are able to be effectively transported, handled, and assembled, even into relatively large lighting structures. Further, the modular lighting assemblies described herein may be transported, assembled, and installed with less cost and difficulty than a similarly sized/shaped arrangement not having the beneficial modular features described herein.

The bottom element 106, side elements 104, and top element 108 may be formed in many different thicknesses. In some cases, these elements may have an average thickness of about 1/64 of an inch, 1/32 of an inch, 1/16 of an inch, ⅛ of an inch, ¼ of an inch, or may have a thickness within a range defined by or between any two of the foregoing values. For instance, the bottom element 106 may have a thickness of ⅛ of an inch, the top element 108 may have a thickness of ¼ of an inch, and the side elements 104 may have a thickness of about 1/32 of an inch. In other cases, the bottom element 106, top element 108, and side elements 104 may each have a thickness of about 1/32 of an inch. Thus, it can be seen that substantially any combination of element thicknesses may be used.

In some embodiments, the lighting modules 102 may have a width (i.e., distance from side element 104a to side element 104b) of about 1.5 inches, 2.0 inches, 2.5 inches, 3.0 inches, or 3.5 inches, or a width within a range defined by or between any two of the foregoing values. Furthermore, the lighting modules 102 may have a height (i.e., distance between the bottom element 106 and the top element 108) of about 2.5 inches, 3.0 inches, 3.5 inches, 3.75 inches, 4.0 inches, 4.5 inches, or 5.0 inches, or a height within a range defined by or between any two of the foregoing values. Other heights and widths for the lighting assembly 100 are also possible.

In one embodiment, the lighting modules 102 have a width of about 2.5 to 3 inches, and a height of about 3.5 to 4 inches. Modules having the foregoing dimensions may provide for a low volume and low profile lighting assembly. Such lighting assemblies are low in profile without being too small so as to disrupt the functional and aesthetic aspects of the assembly. For instance, in some circumstances, a module 102 having a height greater than about 4 to 5 inches may take up too much space for its installation area, and may add too much weight to the assembly. Each lighting assembly may be custom designed for its intended installation area so as to provide an appropriate amount of light in an appropriately-sized form factor. The lighting modules 102 may be formed with any desired length. Some lighting modules 102, for instance, have a length of about 0.5, 1, 2, 3, 4, 5, 6, 8, or 10 feet, or have a length within a range defined by or between any two of the foregoing values.

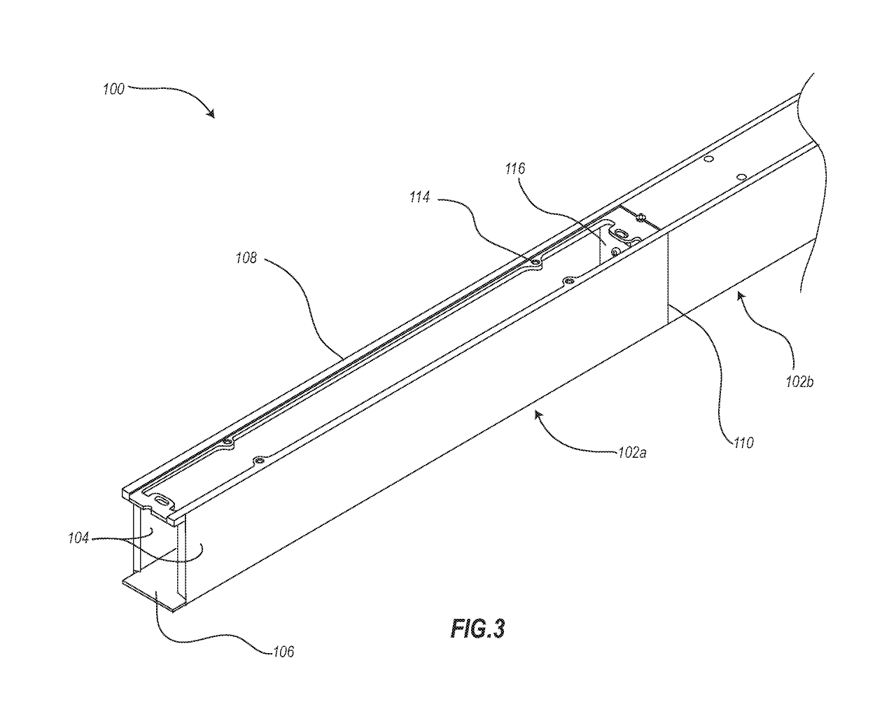

FIG. 3 illustrates the lighting assembly 100 with the cover 112 removed to show the interior of the lighting module 102a, and to show additional features of the top element 108. As illustrated, the top element 108 includes a plurality of connection points 114 for attaching the cover 112. In the illustrated embodiment, the connection points 114 are configured as receiving holes for receiving screws, bolts, or other fastener hardware. These fasteners may be inserted through the access holes 113 in the cover 112. In alternative embodiments, the top element 108 may include one or more clips, tabs, magnetic attachments, or other fastening means for coupling to the cover 112. The connection points 114 provide for a substantially flush placement of the cover 112 onto the top element 108.

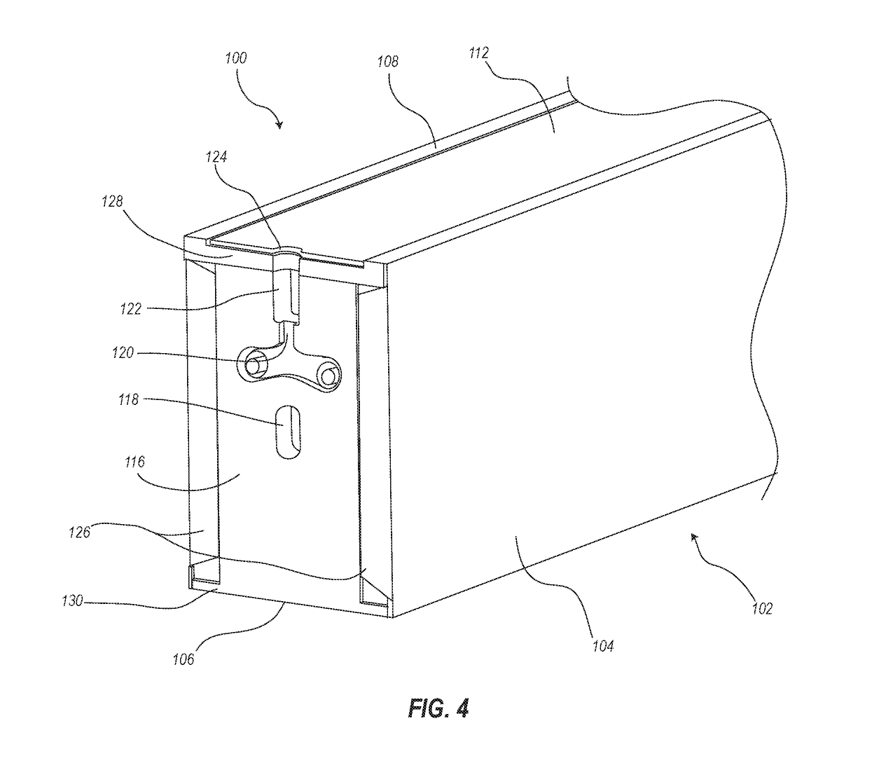

As shown in FIG. 3, the separate modules 102 may be coupled together (e.g., end to end) to form an interface 110. An end member 116 is also visible in FIG. 3. The end member 116 is connected to and is part of the lighting module 102a. In the illustrated configuration, the end member 116 is coupled to a corresponding end member of the lighting module 102b to join the lighting modules together at the interface 110. The end member is shown in greater detail in FIG. 4.

FIG. 4 illustrates an expanded view of a lighting module 102 having an end member 116. As shown, the end member 116 is joined to the top element 108, the bottom element 106, and to the side elements 104. The various elements may be joined using adhesives and/or mechanical fasteners, for example. In the illustrated embodiment, the end member 116 is positioned to be aligned (flush) with the adjoining ends of the top element 108, the bottom element 106, and the side elements 104. As shown, the side elements 104 are positioned against the end member 116 by folding or bending around the end member 116. The end member 116 includes a recess shaped to receive folded sections 126 of the adjoined side elements 104. The recess allows flexible, foldable side elements to be folded into the recess. As such, the thickness of the folded sections 126 can be flush with the extent of the end member 116 when folded around and positioned against the end member 116 (see FIG. 7 as well).

As shown, the folded sections 126 are shaped with a height that is equal to or less than the height of the end member 116. In this configuration, the folded sections 126 do not extend across the end surface 128 of the top section 108 or the end surface 130 of the bottom element 106. This configuration beneficially allows the end surfaces 128 and 130 to be positioned against corresponding end surfaces of an adjoining lighting module, without interference from the folded sections 126 and without the need for forming receiving grooves in the top or bottom elements. Such a configuration also beneficially minimizes the appearance of any seams along the top and bottom surfaces of a lighting assembly arranged using such lighting modules.

The illustrated end member 116 includes a utility aperture 118 and a connection recess 120 having a pair of receiving holes. The aperture 118 may be utilized to pass one or more wires, electrical couplings, or other components from one module to another. As explained in more detail below, the connection recess 120 may be utilized to join the end member 116 to another end member of another lighting module to join the modules. The illustrated end member 116 also includes a channel 122 that corresponds in size and shape with a notch 124 that extends through the top element 108 and the cover 112. As explained in more detail below, the channel 122 and notch 124 allow passage of one or more installation components from an end member to and beyond the top element 108.

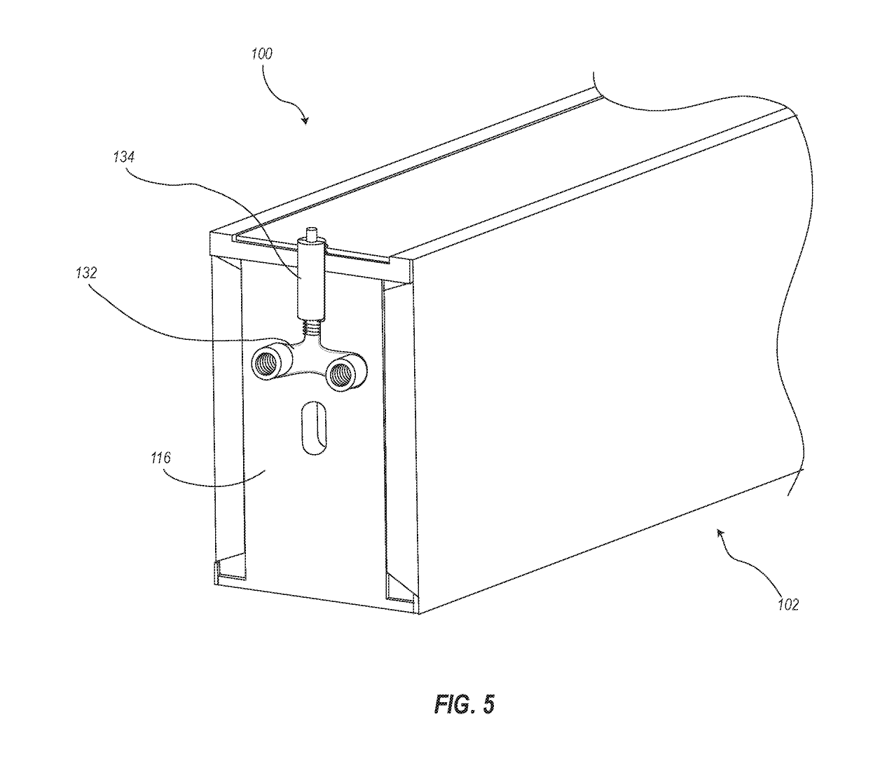

FIG. 5 illustrates a lighting assembly 100 with a bracket 132 attached to the end member 116. As shown, the bracket 132 is sized and shaped to be partially received into the connection recess 120 (of FIG. 4). In the illustrated embodiment, a mounting member 134 is joined to the bracket 132 and is partially nested within the channel 122 and notch 124 to extend out and beyond the top surface of the lighting assembly 100. The mounting member 134 may be configured as a cable grip or cable clamp to enable the assembly to couple to one or more cables for mounting or installation of the lighting assembly. Other embodiments may additionally or alternatively include one or more brackets, mounts, rack components, other mounting hardware, or combinations thereof.

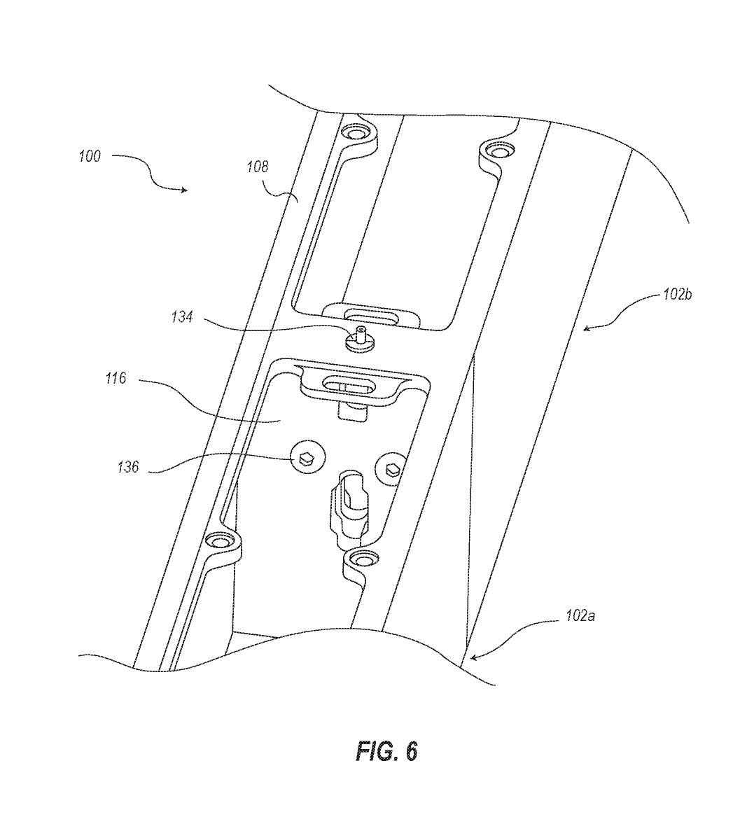

FIG. 6 illustrates a top view of the lighting assembly 100 (with the cover removed) showing end members 116 coupled together to join the separate lighting modules 102a and 102b. In this configuration, connection hardware 136 joins the end members 116. FIG. 6 also illustrates the mounting member 134 extending through to the top surface of the assembly. As shown, the adjoining top elements 108 are able to be positioned flush against one another substantially omitting any gaps, notches, or other module connection artifacts. It will be understood that a similarly flush arrangement of bottom elements is also made possible by this configuration. The mounting member may extend through and out the top of the assembly, or may rise sufficiently to be flush with the top surface of the assembly.

FIG. 7 illustrates another view of the lighting assembly 100. FIG. 7 provides a view that is similar to FIG. 6 but with the top element 108 removed for clarity. From this view, the folded sections 126 are visible and are shown as being disposed within recesses of respective end members 116. The folded sections 126 allow the side elements 104 of different modules (102a and 102b) to abut one another in a flush manner. This allows multiple lighting modules to be joined together while avoiding gaps or large seams that would be visually unappealing.

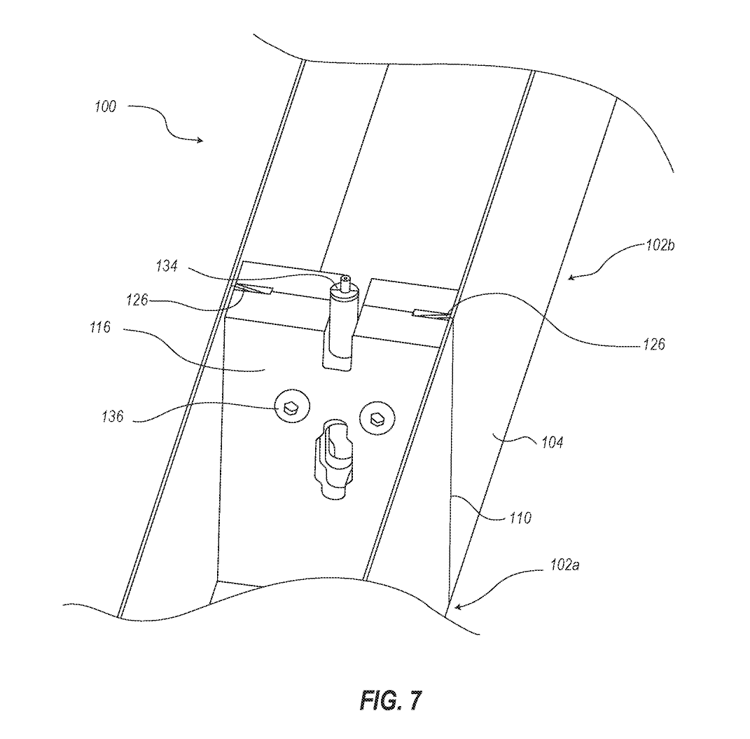

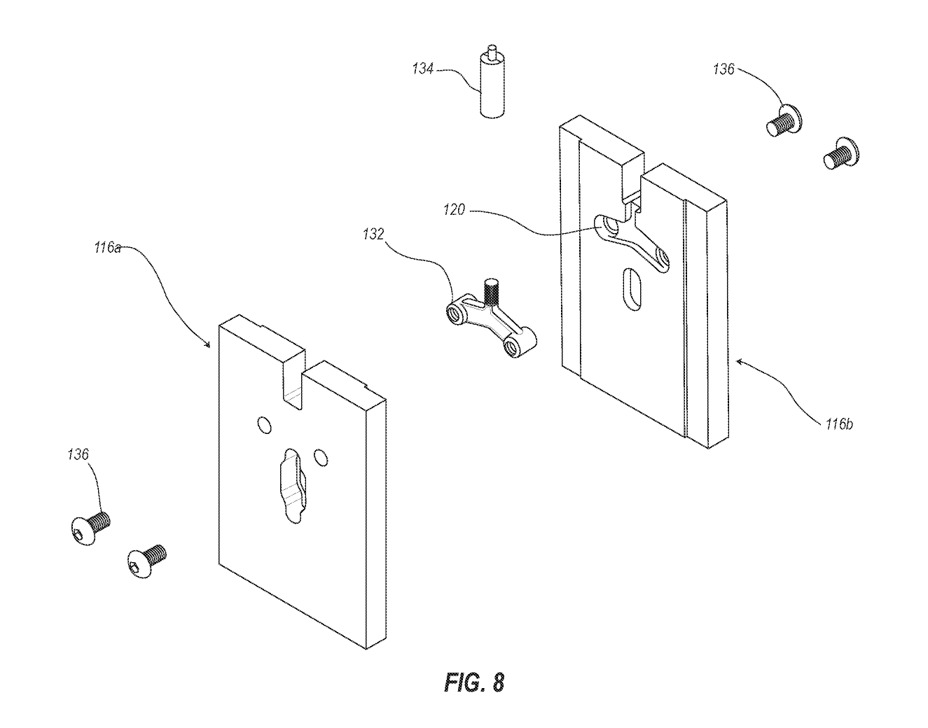

FIG. 8 illustrates an exploded view of a pair of end members 116a and 116b (referred to generically herein as end members 116). As shown in FIG. 8, bracket 132 is configured to receive connection hardware 136 (e.g., bolts, screws, pins, and/or other fastening structures), which are passable through the receiving holes of the end members 116 to engage with the bracket 132, thereby joining the separate end members 116a and 116b. In the illustrated embodiment, the bracket 132 is configured to nest within the connection recesses 120 of both end member 116a and end member 116b (connection recess 120 of end member 116b is shown, the corresponding connection recess of end member 116a is not visible from the illustrated viewpoint). In this way, the end members 116a and 116b are able to abut against one another when coupled, as best seen in FIG. 7.

FIG. 9 illustrates another embodiment of a lighting assembly 100 with a cover 112 lifted away from the top section 108 to reveal the interior space of each lighting module 102. In the illustrated embodiment, the cover 112 has been pulled back from a downward-facing position to a sideways-facing position that shows the attached LED lighting strip 150. When in the downward-facing position, the LED lighting strip 150 will shine light in a primarily downward direction, such that light from the LED lighting strip extends out through the bottom element (e.g. 106 of FIG. 1).

As illustrated in FIG. 9, the wires and associated connectors 138 of the LED lighting strip 150 are passed through an aperture 115 in the end members. This aperture 115 may be the same as or different than the utility aperture 118 of FIG. 4. The wires and associated connectors 138 connect the LED lighting strip 150 of one module to the LED lighting strip of another lighting module. Each LED lighting strip 150 may include substantially any number of LED lights 152, spaced at regular or random intervals. The LED lights 152 may be placed on a LED lighting strip 150, or may be placed on multiple parallel LED lighting strips. The LED light strips 150 may include wire connectors 138 at each end to allow easy connection to other lighting modules.

FIG. 10 illustrates an embodiment of a connecting bracket 1032 that may be utilized to couple two lighting modules together. This bracket 1032 may be used in place of or in conjunction with connecting bracket 132 of FIG. 8. As shown, the connecting bracket 1032 includes an upper receiver 1040 for attaching mounting or installation hardware. The connecting bracket 1032 also includes a connection receiver 1042 for receiving connection hardware connecting separate lighting modules. The connecting bracket further includes a pin 1044 for enhancing the attachment and/or for stabilizing and supporting the connection. The connector may be used to connect lighting modules 102a and 102b, for example, in place of or in addition to the bracket 132 and mounting member 134.

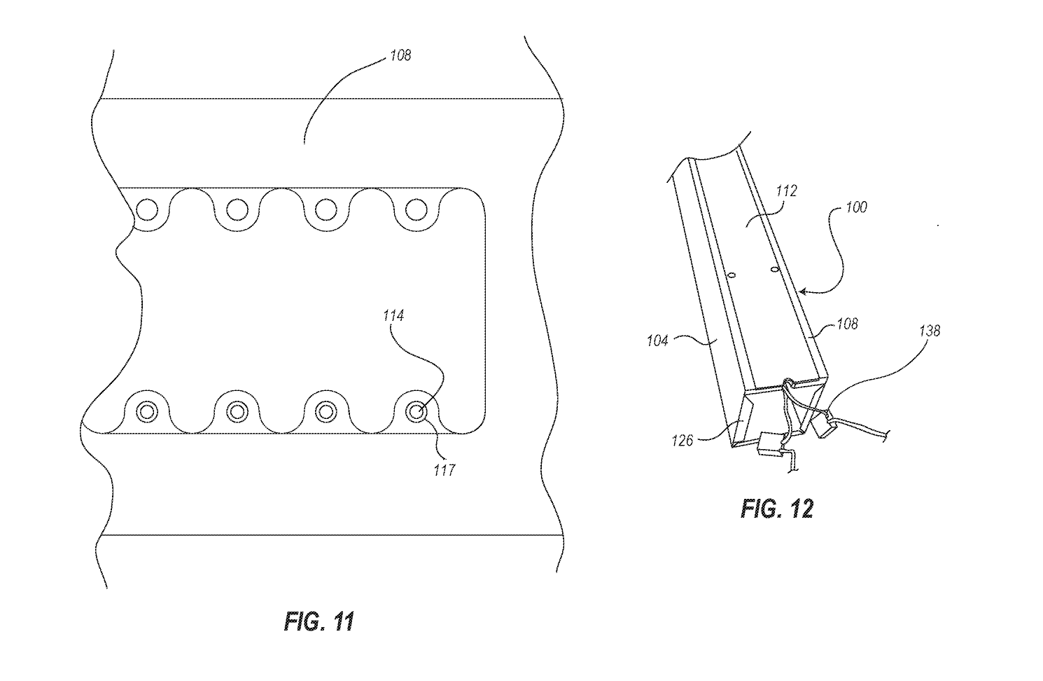

FIG. 11 illustrates a top element 108 of the lighting assembly. In this embodiment, some of the connection points 114 of the top element 108 include an embedded ring structure 117 providing a threaded surface to the connection points 114. The embedded ring structures 117 may be formed from gold or other suitable material, and may be heat set or heat applied to the material of the top element 108. Beneficially, this allows for attachment of the cover and/or other structures to the top element 108 using minimal hardware. For example, where no threads exist in the connection point 114 and/or where threads formed directly into the thermoplastic material of the top element 108 are not mechanically feasible or suitable, additional hardware (e.g., nuts and bolts) is typically required to fasten the cover. In contrast, the embedded ring structures 117 provide threads for which only a single bolt, screw, or similar fastener is required to mechanically fasten the cover to the top element 108.

FIG. 12 illustrates another view of the lighting assembly 100, showing the top surface of the assembly and illustrating that there are substantially no gaps or notches along the side edges of the top surface caused by folded tabs 126 of the side sections 104. Similarly, the bottom element (not shown in this view) maintains a substantially gapless consistency, with minimal gaps only occurring at interfaces between separate modules. In this manner, multiple lighting assemblies 100 may be linked together to form a long strip of lighting. In other embodiments, the lighting assemblies 100 may be linked at 90 degree angles to form L-shaped lights or squares. Still further, the lighting assemblies 100 may be formed in curved pieces to form circles or other shapes. The LED lighting strips may be placed along the interior surface of the cover 112, or alternatively, along the interior surface of one or more of the side elements 104. Still further, the LED lighting strips may be placed on the interior surface of the bottom element 106.

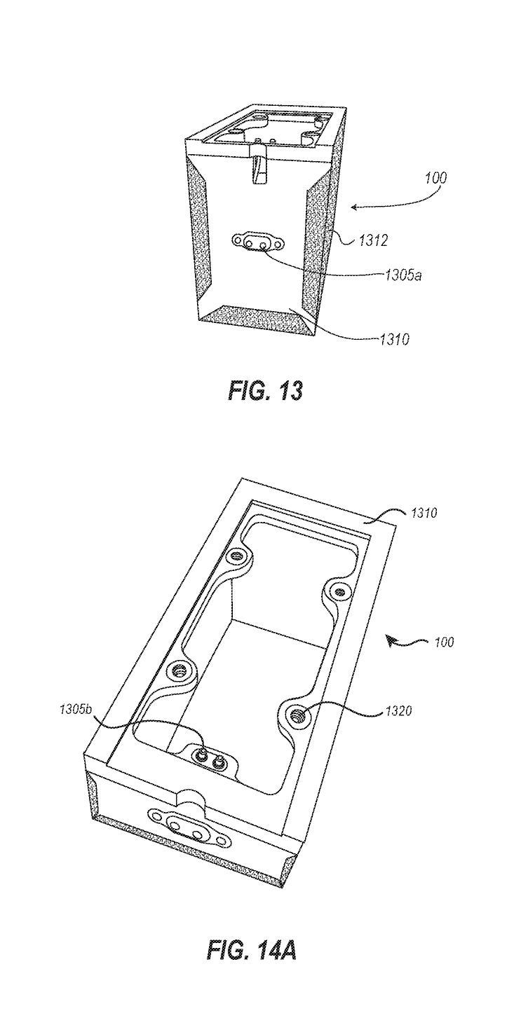

FIG. 13 illustrates a front perspective view of a linear baffle light 100. The linear baffle light 100 includes a substructure 1310 that forms an enclosure for one or more lights (not shown in FIG. 13). The substructure 1310 may include, for example, the top element 108, side elements 104 and bottom element 106 (not shown) of FIG. 1. The linear baffle light 100 further includes a customizable wrap 1312 that surrounds one or more surfaces of the substructure 1310. The customizable wrap 1312 may be opaque, semi-opaque, transparent, or any grade in between. Indeed, in some cases, the customizable wrap is made of a diffusing material (such as those described above) in order to diffuse the light coming from the LED light strip or other light source (e.g. a light bulb).

In one embodiment, the customizable wrap 1312 may be a film lamination wrap. The film lamination wrap may be 1/32″ thick, 1/16″ thick, ⅛″ thick, or some other thickness that is higher than ⅛″ or less than 1/32″. As will be described further below with regard to FIGS. 18-21, the customizable wrap 1312 may be folded, cut or otherwise modified to fit a specific shape or to cover a specific substructure. For example, in one embodiment the lighting assembly substructure 1310 may have a width in the range of 2.5 to 3 inches and a height in the range of 3.5 to 4 inches. The customizable wrap 1312 may be designed to wrap around such a size, with little to no overlap on the ends, thus allowing a flush mount to other lighting assemblies.

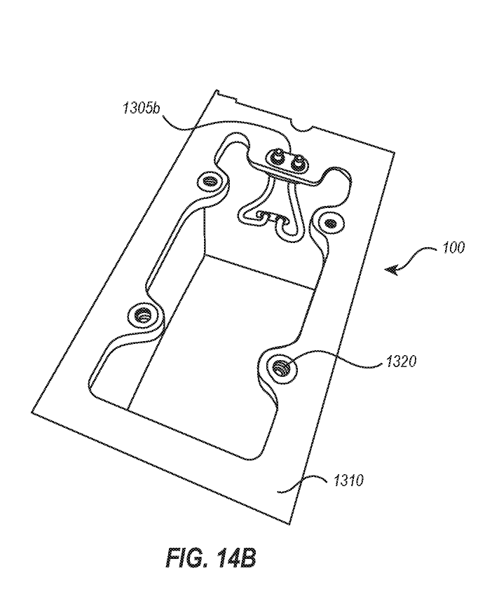

The substructure 1310 and/or the customizable wrap 1312 may include one or more grommets 1320 embedded therein (as shown in FIGS. 14A and 14B) which are configured to connect the linear baffle light to other linear baffle lights, or to allow a cover (e.g. 112) to be fastened thereto. In cases where grommets are used, the grommets may be cold-form grommets embedded directly into the customizable wrap 1312. The grommets allow fasteners such as bolts to be used to fasten other lighting assemblies, or elements of lighting assemblies to the illustrated lighting assembly 100. Although shown on the top of the lighting assembly 100, it will be understood by one skilled in the art that the grommets 1320 or other fasteners may be placed on any surface of the lighting assembly including the top, bottom or side elements.

Electrical connectors 1305a and 1305b (shown in FIGS. 14A and 14B) include contact pins that connect to corresponding contact holes to provide an electrical connection. The contact pins may be embedded in or mounted on the substructure 1310. Although shown as having two electrical connectors 1305A/1305B, it will be recognized that a given linear baffle light 100 may have more or fewer electrical connectors, and that these electrical connectors may be placed substantially anywhere on the linear baffle light.

For example, the linear baffle lights may connect end-to-end using electrical connectors 1305a. One linear baffle light would have a connector with receiving holes (1305a), and a corresponding linear baffle light would have an electrical connector with pins (e.g. 1305b) that would attach to the holes of connector 1305a. Both electrical connectors would be placed in approximately the same position in the substructure 1310. Additionally or alternatively, the linear baffle lights may be stacked on top of each other using electrical connectors 1305a and 1305b. Substantially any number of linear baffle lights 100 may be connected together using such electrical connectors. At least one of the linear baffle lights may be connected directly to a power source such as a wall outlet, a power line from a breaker, or a battery.

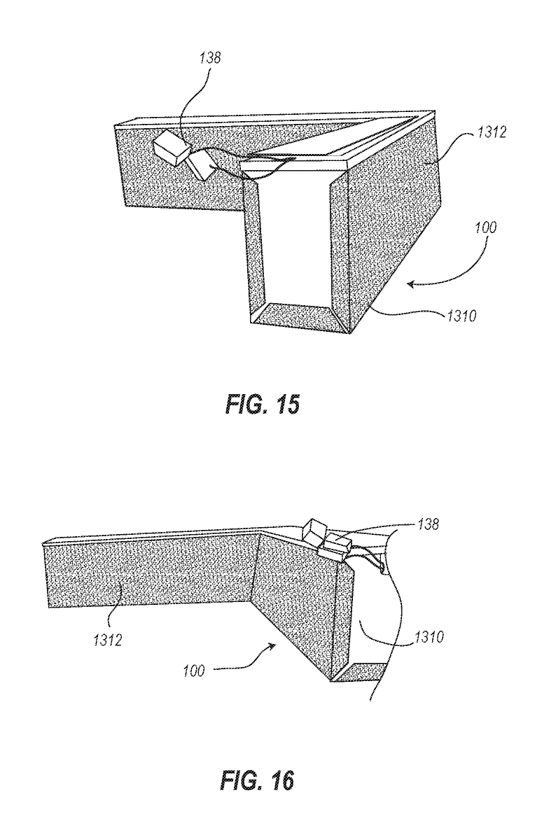

As shown in FIGS. 15 and 16, the lighting assembly 100 may be formed in the shape of an L. The substructure 1310 may extend from one end for a specified length, and then extend 90 degrees for another specified length to an opposite end. Each end of the L-shaped lighting assembly 100 may have an electrical connector 138 for attaching to other lighting assemblies. These L-shaped lighting assemblies may be stacked on top of each other, or may be placed end to end to form a square, or may be arranged in some other manner. Each L-shaped lighting fixture 100 is wrapped with a customizable wrap 1312 that diffuses light output by the lights installed therein. The customizable wrap 1312 is cut or designed to cover each side of the L-shaped lighting assembly 100.

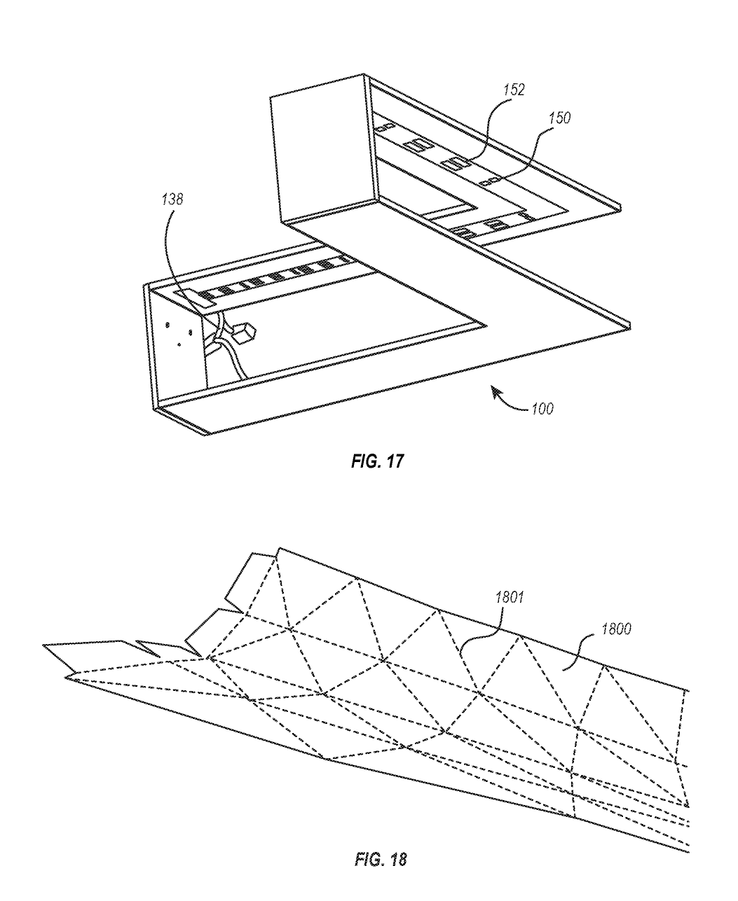

The lights in the L-shaped lighting assembly 100 may be LED lights, as shown in FIG. 17, or may have some other lighting source such as fluorescent or incandescent bulbs. The LED lights 152 may be arranged in LED light strips 150, as shown in FIGS. 9 and 17. The LED light strips 150 may be manufactured or cut to substantially any length, and may be produced in different patterns including grid patterns, parallel strips, perpendicular strips (relative to the length of the lighting assembly 100), L-shaped strips (as in FIG. 17), circular shapes or other patterns. Each LED light strip 150 includes at least one electrical connector 138 that provides a connection to a power source and/or to other lighting assemblies. The electrical connector 138 may include a snap connector that provides a snap fit to other linear baffle lights, allowing them to be removably attached to one another. This snap connector allows users of the linear baffle lights to easily connect and disconnect the lights without having to use long cords.

In some cases, the electrical connector 138 may include or electrically connect to electrical traces that run through the customizable wrap 1312 to the LED light strips 150. In this manner, a lighting assembly with LED light strips and electrical traces may be embedded directly in the customizable wrap 1312. This allows easy installation, and easy hook-up to power. Moreover, wraps may be placed over or around a given substructure. For example, if a user wanted a different style or color of lighting or amount of diffusion, the user could simply remove the wrap and insert a different wrap. The embedded lights in the new wrap would include electrical connectors 138 that could be inserted into the end pieces (e.g. 116 of FIG. 6), and could thus connect to other lighting assemblies. In cases where the LED light strip is embedded in the customizable wrap 1312, the wrap may appear as if it were a sheet of paper, with a circuit and LEDs embedded on it. The wrap can then just be cut out to a size or shape the user wants, and then glued or otherwise fastened to the lighting assembly substructure 1310.

In FIGS. 15 and 16, the customizable wrap 1312 is formed around an L-shaped substructure 1310. In FIG. 13, the customizable wrap 1312 is formed around a rectangular substructure 1310. As shown in FIGS. 18-21, the customizable wraps 1800 may be folded or bent, creating the dotted lines 1801 shown in the illustrations. These customizable wraps 1800 (which may be the same as or different than the customizable wrap 1312) may be thin veneer wraps (e.g. 1/32″ thick) and may thus be folded into a desired shape. For example, a veneer wrap 1800 may be folded around a rectangular box substructure (e.g. 1310 of FIG. 13), or around an L-shaped substructure 1310 of FIGS. 15 and 16, or around a square box substructure, or around a cylindrical substructure, etc.

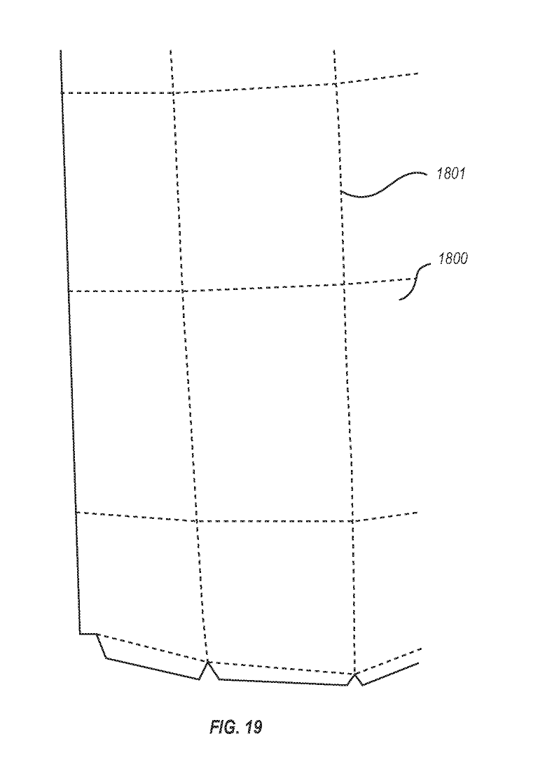

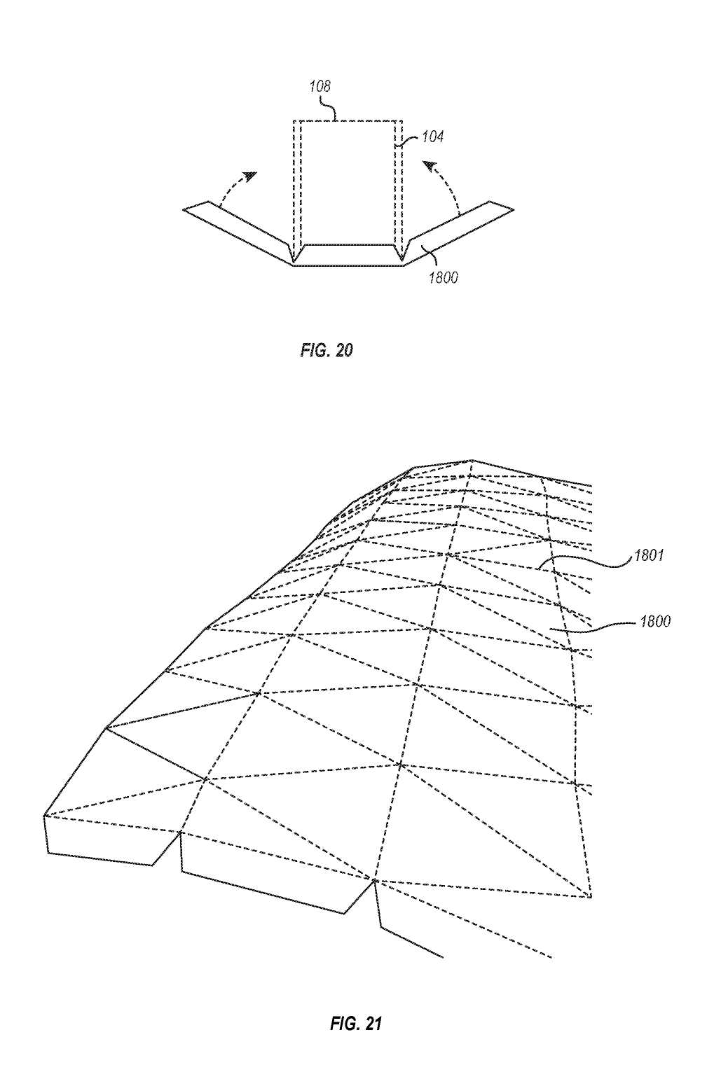

FIG. 19 illustrates an embodiment in which a veneer wrap 1800 is folded along horizontal and vertical lines 1801. These dotted lines show example folding positions. Indeed, it will be recognized that the veneer wrap 1800 may be folded in substantially any manner. FIGS. 20 and 21 illustrate examples of how the veneer wrap can be folded along different lines, and cut where needed (e.g. at 1802) using scissors or other cutting tools. FIG. 20 shows how the veneer wrap 1800 can be wrapped around a substructure (e.g. 1310) having side elements 104 and a top element 108. The wrap is cut to size, folded along lines 1801, and potentially trimmed at 1802 to allow for folding without overlap. The veneer wrap may then be secured to the lighting module using any of a variety of different fastening means.

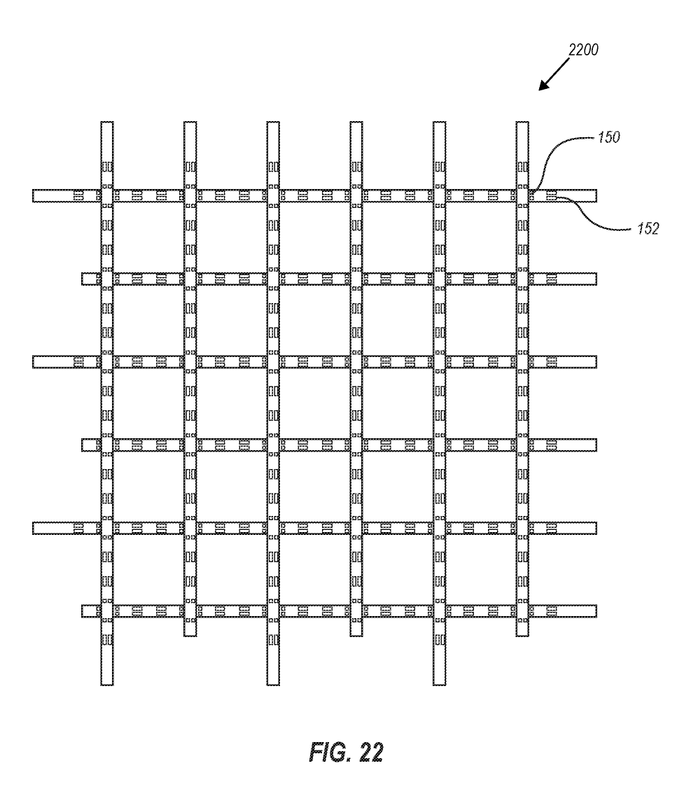

Thus, in this manner, a customizable veneer wrap may be applied to linear (or other shaped) baffle lights. The wrap may be cut to fit onto many different sizes or shapes of lighting fixtures. By implementing LED lighting strips with easy-to-use snap-fit connectors, each light assembly is modular and can be combined with other lighting assemblies to create a truly unique and customized light fixture. The LED lighting strips may be applied as single strips, or may be organized in a grid (e.g. grid 2200 of FIG. 22). This grid of LED lighting strips 2200 may be used in conjunction with the customizable wraps described above to create highly illuminated lighting fixtures in many different shapes and sizes. Each portion of the grid may be designed with a snap-fit connection. As such, sections of LED lighting may be added or removed to accommodate design features of the light. Moreover, other single- or multi-strip LED lighting strips may be added thereto to create still different shapes and sizes of lighting fixtures. Furthermore, one grid of LED lighting strips 2200 may be attached to other grids of LED strips to create larger and more elaborate lighting fixtures.

Accordingly, in some embodiments, a lighting module is configured in size and shape to provide a low volume profile for providing lighting with efficient use of available space. In some embodiments, a lighting module is configured with a low volume profile so as to minimize material requirements, object weight, and/or space demands. The lighting modules may include coupling components that function to enable simple connection of the lighting modules for forming a modular lighting assembly. In certain embodiments, the coupling components are configured to provide for ease of assembly, short assembly times, and/or limited hardware requirements.

The thin veneer wraps described herein may be applied to lighting fixtures in a variety of different manners. In some cases, the wraps may have patterns or different diffusing areas that will cause the light passing through them to have different visual effects. In some cases, multiple veneer wraps may be layered and applied on top of one another. This may allow one layer to provide a first lighting effect, and another layer to provide another lighting effect. In other cases, holes may be cut in one part of the wrap (or in one layer of the wrap) to provide certain lighting effects. In still other cases, the wrap may be folded in upon itself in places to create a double or triple layer of wrap in those spots. This may also have visual effects on the light that is diffused by the wrap. Accordingly, many modifications may be made to the wrap to change how the light from the LED light strips is diffused out of the lighting modules.

Elements described in relation to any embodiment depicted and/or described herein may be combinable with elements described in relation to any other embodiment depicted and/or described herein. Indeed, the concepts and features described herein may be embodied in other specific forms without departing from their spirit or descriptive characteristics. The described embodiments are to be considered in all respects only as illustrative and not restrictive. The scope of the disclosure is, therefore, indicated by the appended claims rather than by the foregoing description. All changes which come within the meaning and range of equivalency of the claims are to be embraced within their scope.

We claim:

1. A lighting assembly, comprising:
a lighting module, the lighting module including:
one or more lighting components;
a bottom element configured to at least partially transmit light emitted from the one or more lighting components when the one or more lighting components are illuminated; and
an end member coupled to the bottom element, the end member having an interior recess for at least partially receiving a connecting bracket, the connecting bracket being configured to enable coupling of the end member of the lighting fixture to another end element of another lighting fixture.

2. The lighting assembly of claim 1, further comprising a top element and one or more side elements extending from the bottom element to the top element, and further comprising a cover detachably connected to the top element, wherein the one or more lighting components are attached to the cover on an inner side of the cover facing the bottom element.

3. The lighting assembly of claim 1, wherein the connecting bracket is configured to be disposed entirely between the top element and the bottom element.

4. The lighting assembly of claim 1, wherein the top element includes one or more connection points for coupling the cover to the top element, the one or more connection points including an embedded ring formed with threads to enable the receiving of threaded connection hardware at the one or more connection points.

5. The lighting assembly of claim 1, wherein the end member includes first and second side recesses for receiving folded over ends of respective side elements of the assembly, the side recesses being sized so that the folded over ends are aligned flush with the end member when disposed within respective recesses.

6. The lighting assembly of claim 5, wherein the first and second side recesses and the folded over sections have a height that does not extend across at least one of an end surface of the top element or the bottom element.

7. The lighting assembly of claim 1, further comprising a mounting member attached to the connecting bracket and extending from the connecting bracket through the top element and beyond the top element.

8. The lighting assembly of claim 7, wherein the end member includes a channel extending from the interior recess to the top element, and wherein the top element and the cover each include a notch corresponding in size and shape with the channel so as to allow passage of the mounting member through the channel and the notches.

9. A linear baffle light, comprising:
a substructure that forms an enclosure for one or more lights;
a customizable wrap that surrounds one or more surfaces of the substructure;
one or more fasteners embedded in the customizable wrap configured to connect the linear baffle light to one or more other linear baffle lights; and an electrical connector comprising one or more contact pins, wherein
the contact pins are embedded in the customizable wrap.

10. The linear baffle light of claim 9, wherein the customizable wrap comprises a film lamination wrap.

11. The linear baffle light of claim 10, wherein the film lamination wrap has a thickness in a range of 1/16 to 1/32 inches.

12. The linear baffle light of claim 9, wherein the one or more fasteners comprise cold-form grommets embedded directly into the customizable wrap.

13. The linear baffle light of claim 9, wherein the one or more lights comprise LED lights arranged in an LED light strip.

14. The linear baffle light of claim 13, wherein the LED light strip is embedded in the customizable wrap.

15. The linear baffle light of claim 9, wherein the electrical connector includes at least one snap connector that allows multiple linear baffle lights to be connected together.

16. The linear baffle light of claim 15, wherein the electrical connector includes electrical traces that run through the customizable wrap to the one or more lights.

17. The linear baffle light of claim 9, wherein the customizable wrap is cuttable, allowing the linear baffle light to be cut to fit into different sizes or shapes.

18. A lighting assembly, comprising:
a first lighting module, the first lighting module including:
one or more lighting components;
a bottom element configured to at least partially transmit light emitted from the one or more lighting components when the one or more lighting components are illuminated; and
an end member coupled to the bottom element, the end member having an interior recess for at least partially receiving a connecting bracket, the connecting bracket being configured to enable coupling of the end member of the lighting fixture to another end element of another lighting fixture; and
a second lighting module, the second lighting module including an end member joined to the end member of the first lighting module via the connecting bracket.

19. The lighting assembly of claim 18, wherein the connecting bracket is partially disposed within a recess of the end member of the first lighting module and is partially disposed within a recess of the end member of the second lighting module.

20. The lighting assembly of claim 19, wherein each of the end members includes aligned connection holes enabling the passage of connection hardware through the respective end member and to the connecting bracket disposed within the adjoined end members.
